(19) United States
(12) Patent Application Publication
(10) Pub. No.: US 2008/0043469 A1
(43) Pub. Date: Feb. 21, 2008

(54) Lighting device and microscope system

(75) Inventors: Hideo Watanabe, Tokyo (JP); Hiroshi Watanabe, Tokyo (JP)

Correspondence Address: Thomas Spinelli;Scully, Scott, Murphy & Presser, 400 Garden City Plaza, Garden City, NY, 11530, US

(73) Assignee: Olympus Corporation, Tokyo (JP)

(21) Appl. No.: 11/810,088

(22) Filed: Jun. 4, 2007

(30) Foreign Application Priority Data
Jun. 5, 2006 (JP) 2006-155698

(51) Int. Cl. G01N 21/00

(52) U.S. Cl. 362/257

(57) ABSTRACT

This lighting device comprises a plurality of wavelength range extraction unit for extracting light in different wavelength ranges from light of a light source, a shutter unit for shutting each piece of light extracted by each of the wavelength range extraction units, a selector unit for selecting light to be shut by the shutter unit, and a combiner unit for combining a plurality of pieces of light that is not shut by the shutter unit.

### CROSS REFERENCE TO RELATED APPLICATIONS

This application claims the benefits of Japanese Application No. 2006-155698 filed Jun. 5, 2006, the contents of which are incorporated by this reference.

### BACKGROUND OF THE INVENTION

1. Field of the Invention

The present invention relates to a lighting technology, and more particularly to a technology for obtaining specific light used to observe an object to be inspected.

2. Description of the Related Art

It is considered to extract light in an arbitrary wavelength range from a light source with wide-ranged spectral distribution. As one of these general and simple methods, a method for branching luminous flux from the light source into a plurality of pieces and reflecting or transmitting light in a desired wavelength by disposing a dichroic mirror or a band-pass filter in each pieces of luminous flux is used. In this method, when condensing branched pieces of luminous flux, the condensation point (hereinafter called “selected wavelength condensation position”) can be handled as a new light source.

In each piece of branched luminous flux, a luminous flux shutting material, such as a reclosable shutter or the like, is disposed and each piece of branched luminous flux is condensed after recombining it. Thus, by opening/closing the luminous flux shutting material, a plurality of wavelength ranges can be selectively combined in spectral distribution obtained by condensing light to the selected wavelength condensation position.

A lighting device provided with such an optical system can be used, for example, as a microscopic light source unit in an inspection apparatus for a semiconductor or the like. In this inspection apparatus, by applying light obtained by this lighting device to an object to be observed or measured and taking a picture of the object by a video-camera, whether or not there is a defect in the object can be checked. In this case, if an appropriate light source wavelength is selected according to an object to be observed or measured, the defect or the like of the object can be extracted on the basis of a difference between a plurality of pieces of image information obtained by applying different wavelengths.

Recently, in order to improve the resolution of observation and inspection, a light source with a wavelength in the deep ultraviolet range has been used for lighting.

Concerning the present invention, for example, Japanese Patent Application No. H6-18406 discloses a light source device for switching two pieces of wavelength excitation light in high speed and stably in such a way as to alternately shut the optical paths of two kinds of luminous flux with different wavelengths by a rotary shutting plate.

For example, Japanese Patent Application No. H8-512137 also discloses a technology for modulating a light source in such away that light can be alternately emitted from another different light source emitting light with a different wavelength.

Furthermore, for example, Japanese Utility Model Registration No. 3115100 discloses a microscope capable of checking a selected wavelength by branching part of light applied to a specimen whose wavelength is selected and transmitting it outside a case.

However, when using the lighting device in the inspection apparatus, there are the following problems.

Firstly, when obtaining the image data of an object to be inspected while changing its observation condition by switching a plurality of light sources with different wavelength ranges, the acquisition efficiency of image data remarkably deteriorates compared with when obtaining image data by a single wavelength.

For example, if an object to be inspected is a semiconductor when applying light with a wavelength in the deep violet range to the object for a long time, a resist film is damaged. Therefore, it is preferable to reduce lighting time to an object to be inspected as much as possible to suppress damage to a specimen.

### SUMMARY OF THE INVENTION

The lighting device in one aspect of the present invention comprises a plurality of wavelength range extraction units for extracting light with different wavelength ranges from light emitted from a light source, a shutter unit for shutting each piece of light extracted by each of the wavelength range extraction units, a selector unit for selecting light to be shut by the shutter unit, and a combiner unit for combining a plurality of pieces of light that is not shut by the shutter unit.

The above-described microscope system provided with the lighting device of the present invention is also included in the present invention.

### BRIEF DESCRIPTION OF THE DRAWINGS

The present invention will be more apparent from the following detailed description when the accompanying drawings are referenced.

FIG. 1 shows the configuration of the microscope system of the present invention.

FIG. 2 shows the first example of the internal configuration of the wavelength range selector unit in the microscope system of the present invention shown in FIG. 1.

FIG. 3 shows the example of a user interface screen (No. 1).

FIG. 4 shows the example of a mode setting screen (No. 1).

FIG. 5 shows the example of a synchronization setting screen (No. 1).

FIG. 6 shows the example of a user interface screen (No. 2).

FIG. 7 shows the timing of each control signal in a “TV camera reference mode (Exposure type)”.

FIG. 8 shows the example of a user interface screen (No. 3).

FIG. 9 shows the example of an ND offset adjustment screen.

FIG. 10 shows the timing of each control signal in a “TV camera reference mode (VSYNC type)”.

FIG. 11 shows the example of a user interface screen (No. 4).

FIG. 12 shows the timing of each control signal of the one-shot operation in the “TV camera reference mode (Exposure type)”.

FIG. 13 shows the example of a user interface screen (No. 5).

FIG. 14 shows the timing of each control signal in the sequent screen taking-in operation.

FIG. 15 shows the second example of the internal configuration of the wavelength range selector unit in the microscope system shown in FIG. 1.

FIG. 16 shows the example of a mode setting screen (No. 2).

FIG. 17 shows the example of a synchronization setting screen (No. 2).

FIG. 18 shows the timing of each control signal in a “unit reference mode”.

FIG. 19 shows the timing of each control signal of the one-shot operation in the “unit reference mode”.

FIG. 20 shows the example of a mode setting screen (No. 3).

FIG. 21 shows the third example of the internal configuration of the wavelength range selector unit in the microscope system shown in FIG. 1.

FIG. 22 shows the fourth example of the internal configuration of the wavelength range selector unit in the microscope system shown in FIG. 1.

### DESCRIPTION OF THE PREFERRED EMBODIMENTS

The preferred embodiments of the present invention are described below with reference to the drawings.

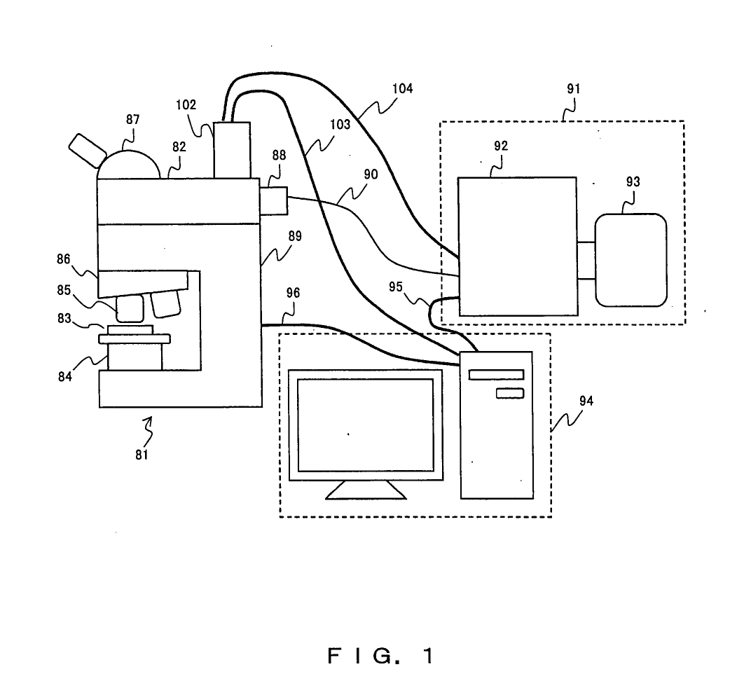

Firstly, FIG. 1 is described. FIG. 1 shows the configuration of the microscope system of the present invention. This system comprises a microscope 81, a lighting wavelength selector unit 91 and a control unit 94 for controlling them. Of these, the lighting wavelength selector unit 91 and the control unit 94 constitute a lighting device.

The microscope 81 comprises an illumination and imaging unit 82, a stage 84, a revolving nosepiece 86 and an eyepiece unit 87, which are mounted on a base 89. The illumination and imaging unit 82 comprises a connector 88 to which an optical fiber 90 for transmitting lighting light emitted from the wavelength range selector unit 92 and a video-camera 102. The stage 84 is used to mount a specimen 83. The revolving nosepiece 86 mounts an object lens 85.

The lighting wavelength range selector unit 91 comprises a lamp house provided with light source 1 and a wavelength range selector unit 92. The wavelength range selector unit 92 is connected to the video-camera 102 by a signal cable 104 for transmitting a synchronous signal.

The control unit 94 comprises, for example, a general-purpose computer and a monitor device for displaying various types of information screen and images. The general-purpose computer constituting the control unit 94 comprises, for example, a microprocessor (MPU) for controlling the operation of the entire microscope system by executing a control program, main memory used by this MPU as work memory as requested, an input unit for obtaining various types of instructions from the user of a mouse device, a keyboard and the like, an interface unit for managing the exchange of various types of data between the components of this microscope system and auxiliary storage devices, such as a hard disk and the like for storing various types of programs and data.

The control unit 94 is connected to the microscope 81 and the wavelength range selector unit 92 by control cables 95 and 96, respectively, for transmitting various types of control signals. The control unit 94 has a function to take in and record the observation image of a specimen 83, which is sensed by the video-camera 102 and is connected to the video-camera 102 by a signal cable 103 for transmitting image signals.

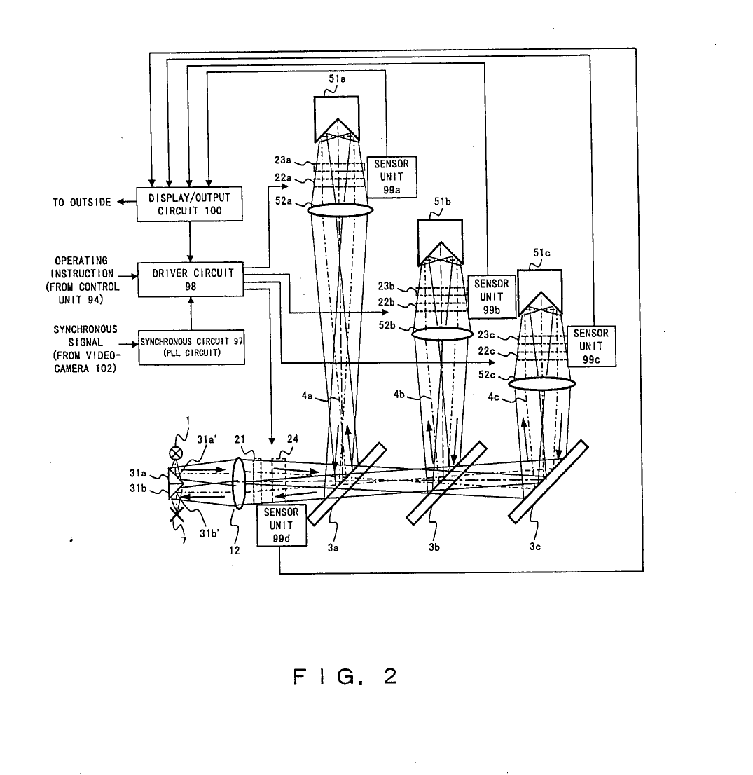

Next, FIG. 2 is described. FIG. 2 shows the first example of the internal configuration of the wavelength range selector unit 92 in the microscope system shown in FIG. 1.

The optical system shown in FIG. 1 branches luminous flux from a light source 1 into a plurality of pieces condenses the branched luminous flux on a selected wavelength condensation position 7 after selecting light with a desired wavelength range from each piece of luminous flux.

This optical system comprises a light source 1, total reflection mirrors 31a and 31b, a collector/condenser lens 12, an ND filter 21, a light source shutter 24, dichroic mirrors 3a-3c, condenser lens 52a-52c, ND filters 22a-22c, shutters 23a-23c, and corner cubes 51a-51c.

In this case, a mercury xenon lamp is used as the light source 1. The wavelength ranges of light reflected by the dichroic mirrors 3a-3c for extracting light in different wavelength ranges from light emitted from the light source 1 are 240-290 nm, 290-330 nm and 330-385 nm, respectively. For the purpose of an easy later description, the channel numbers of these wavelength ranges are defined to be CH1: 330-385 nm, CH2: 290-330 nm and CH3: 240-290 nm, respectively, in the descending order. Thus, the wavelength range of light extracted by the dichroic mirrors 3a-3c can be specified by displaying these channel numbers.

The inner surface of each of the ND filters 21 and 22a-22c is mesh-structured and the mesh density varies depending on the rotation angle of the inner surface. In this case, ones structured to mechanically shut luminous flux are used as the shutters 23a-23c and the light source shutter 24.

The reflection surface 31a′ of the total reflection mirror 31a is inclined to 45 degrees against the optic axis of the collector/condenser lens 12 and an optic axis formed by the light source 1 and the reflection surface 31a′ is disposed in a position shifted in parallel with the optic axis of the collector/condenser lens 12. The reflection surface 31b′ of the total reflection mirror 31b is disposed as opposed to the reflection surface 31a′ of the total reflection mirror 31a against the optic axis of the collector/condenser lens 12. Thus, the selected wavelength condensation position 7 is located as opposed to the light source 1 against the optic axis of the collector/condenser lens 12.

Each of the dichroic mirrors 3a-3c is inclined to 45 degrees against the optic axis of the collector/condenser lens 12. The collector/condenser lens 12, the dichroic mirrors 3a-3c, the condenser lens 52a-52c and the corner cubes 51a-51c are configured a coaxial optical system, and the collector/condenser lens 12 and the condenser lens 52a-52c are disposed to form a both side telecentric optical system. Furthermore, the corner cubes 51a-51c are shifted to the optic axis direction, adjusted and disposed in such a way that the conjugate image of the light source 1 can be formed on the center axis of the condenser lens 52a-52c. Thus, of a plurality of pieces of light each with a different wavelength range, extracted by the dichroic mirrors 3a-3c, one that is not shut by the shutters 23a-23c is combined and condensed on the selected wavelength condensation position 7 by being reflected by or transmitted through the dichroic mirrors 3a-3c. This condensed light is transmitted to the microscope 81 via an optical fiber 90 and is applied to a specimen 83 as lighting light.

Each of the ND filter 21 and the light source shutter 24 is disposed in one position between the light source 1 and the dichroic mirrors 3a-3c. Each of the ND filters 22a-22c and the shutters 23a-23c is disposed in one position in the optical paths 4a-4c. The rotation of the ND filters 21 and 22a-22c and the opening/closing of the shutters 23a-23c and the light source shutter 24 can be externally controlled and operated by a driver circuit 98.

Each of the ND filters 21 and 22a-22c, the shutters 23a-23c, and the light source shutter 24 is provided with sensor units 99a-99d for detecting the origin position and the opening/closing state at the time of initialization and a signal outputted from each of the sensor units 99a-99d is reported to the driver circuit 98 via a display/output circuit 100. The driver circuit 98 controls the operations of the ND filters 21 and 22a-22c, the shutters 23a-23c and the light source shutter 24 according to this signal.

The display/output circuit 100 visually reports the transmitting/shutting state of each of the shutters 23a-23c and the light source shutter 24 by displaying it using a display device, such as a light emitting diode (LED) or the like, which is not shown in FIG. 2, and also outputs a data signal indicating the state.

The light source shutter 24 is connected to an interlock circuit as a safety device, which is not shown in FIG. 2 and compulsorily shuts an optical path at the time of work, such as some abnormality, maintenance and the like.

The synchronous circuit 97 comprises a phase locked loop (PLL) circuit, and synchronizes the control timing of the driver circuit 98 with the synchronous signal of the video-camera 102.

The wavelength range selector unit 92 has such an optical system and has a function to change the transmittance of light in each wavelength range by controlling the rotation on the inner surface of the ND filters 21 and 22a-22c and a function to shut the optical paths 4a-4c by controlling the shutters 23a-23c.

Next, the operation in the case where in the microscope system configured above, light in at least one or more wavelength ranges is selected for lighting and a specimen 83 is consecutively shot is described.

The user of the microscope system gives an instruction to the control unit 94 to execute a control program stored in advance in the control unit 94. Then, the control unit 94 controls the driver circuit 98 to initialize each of the ND filters 21 and 22a-22c, the shutters 23a-23c and the light source shutter 24. In this case, the transmittance of the ND filters 21 and 22a-22c is made 100% and also the light source shutter 24 opens, while the shutters 23a-23c are closed and as a result, all the optical paths 4a-4c are shut.

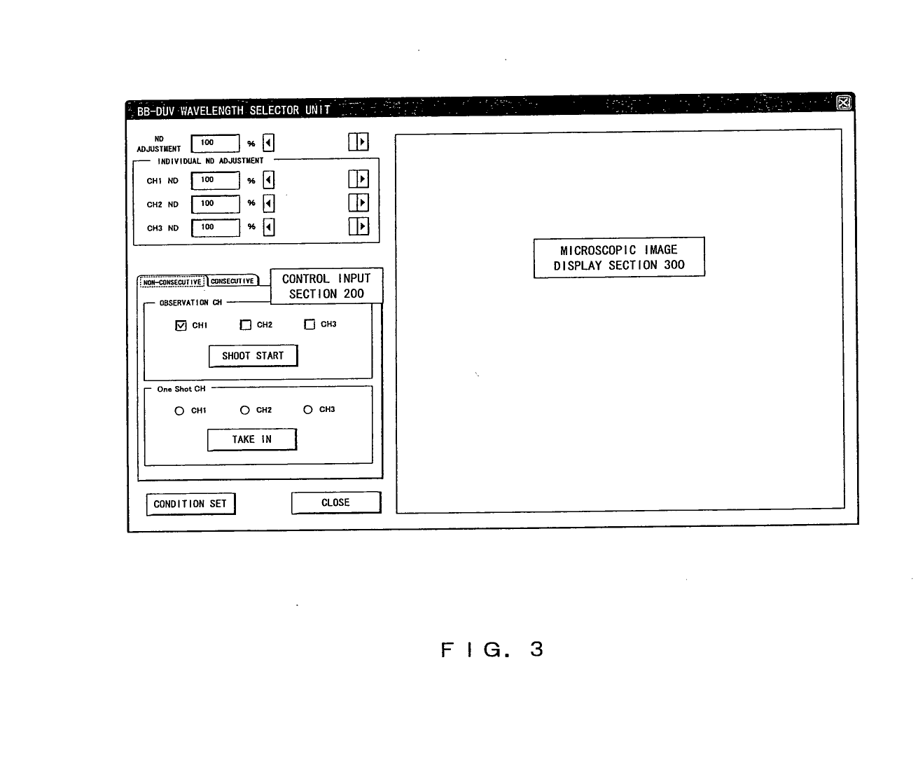

By the execution of this control program, the monitor device of the control unit 94 displays the user interface screen as example in FIG. 3.

On the left side of the screen shown in FIG. 3, a control input section 200 is disposed and on the right side, a microscopic image display section 300 is disposed. In this case, various types of operations on the control input section 200 are made by the user clicking and dragging a mouse device provided for a computer constituting the control unit 94 or pushing down a keyboard.

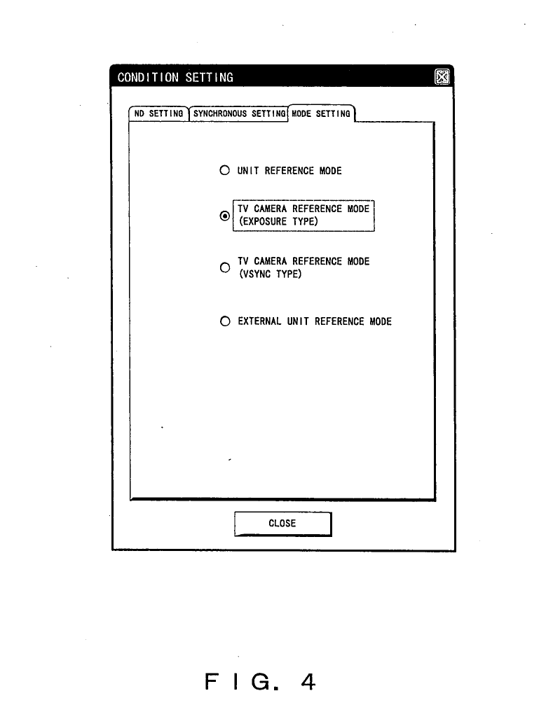

When a button “condition set” disposed in the lower left section is pushed down in the screen shown in FIG. 3, a condition setting screen is displayed on the monitor device. Then, when a tab “mode setting” included in the condition setting screen is selected, the mode setting screen shown as an example in FIG. 4 is displayed on the condition setting screen.

The mode setting screen is used to set the operation method of the lighting wavelength range selector unit 91. In this case, as shown in FIG. 4, it is assumed that the user selects, for example, a radio button “TV camera reference mode (Exposure type)”. In this mode, the wavelength range selector unit 92 operates following the synchronous signal (exposure timing signal) of the video-camera 102.

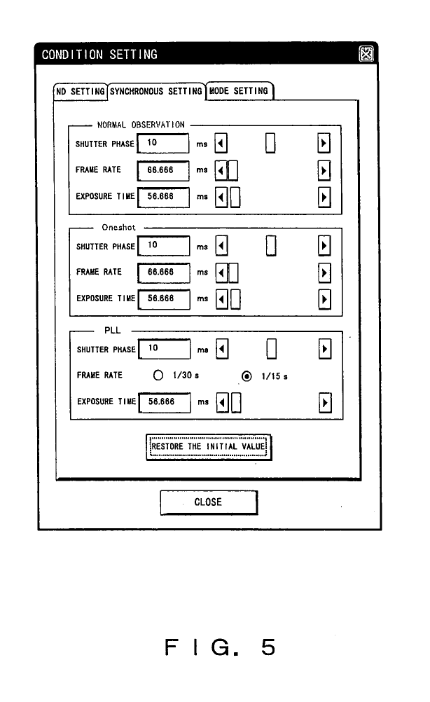

Then, when a “synchronous setting” tab included in the condition setting screen is selected, the synchronous setting screen shown as an example in FIG. 5 is displayed on the condition setting screen.

The synchronous setting screen is used to set a relationship of synchronization between the control timing of the driver circuit 98 in the wavelength range selector unit 92 and the synchronous signal of the video-camera 102. The example screen shown in FIG. 5 indicates the state where of three fields of “normal observation”, “one shot” and “PLL”, only “PLL” is valid.

In this field “PLL”, an item “shutter phase” sets time which is made to delay when the shutters 23a-23c are opened/closed (settling time). An item “frame rate” selects a frame rate when imaging a dynamic image by the video-camera 102 and selects either 1/30 second or 1/15 second by the radio button. Furthermore, an item “exposure time” sets the actual exposure time (shutter speed) of the video-camera 102. By these settings, the selection of a lighting light wavelength range by the wavelength range selector unit 92 can be synchronized with the image taking-in of the video-camera 102 in the prescribed timing thanks to the functions of the synchronous circuit 97.

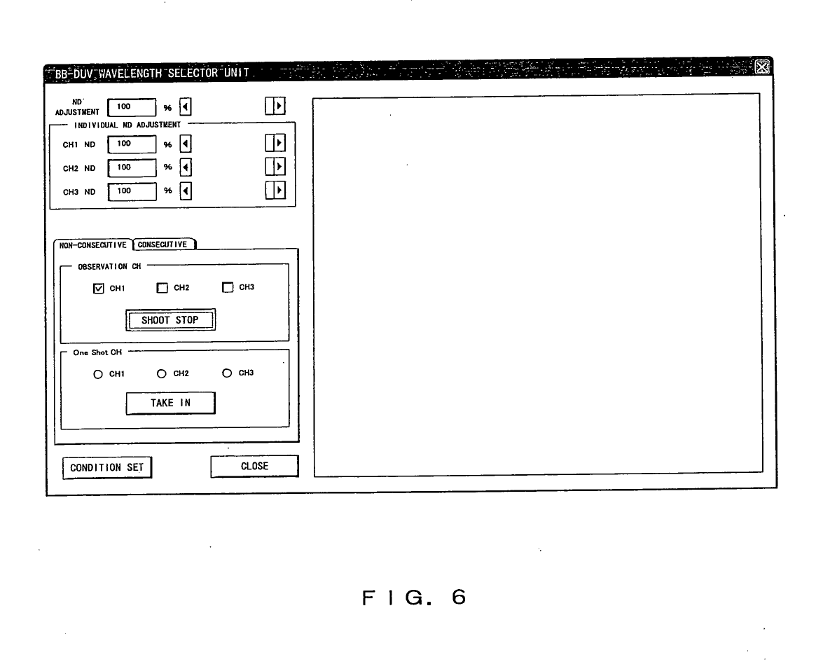

Then, a button “close” disposed in the lower section of the condition setting screen is pushed down, the condition setting screen closes and the original user interface screen shown in FIG. 3 is displayed. In this case, after selecting a checkbox “CH1” in the field “observation CH” of the control input unit 200, a button “shooting start” is pushed down. Then, the control unit 94 changes this user interface screen as shown in FIG. 6 and changes the button “shoot start” to a button “shoot stop”.

When detecting the pushing-down of the button “shoot start”, the control unit 94 instructs the wavelength range selector unit 92 to use light in a wavelength range corresponding to the selected observation channel as lighting light via the control cable 95. Then, the control unit 94 takes in the image shot by the video-camera 102. Simultaneously, the control unit 94 opens only one corresponding to the setting in the field “observation CH” on the user interface screen (shutter 23c corresponding to the check box “CH1” in the example shown in FIG. 6) of the shutters 23a-23c and designates light in the selected wavelength range (optical path 4c) as lighting light. Specifically, the driver circuit 98 selects light to be shut by the shutters 23a-23c.

In this case, since the display/output circuit 100 lights a display device corresponding to the opened one of the shutters 23a-23c, the user can know that the optical path 4c is appropriately opened.

The taking-in of images can be terminated later by pushing down the button “shoot stop” disposed in the field “observation CH” of the control input unit 200 on the user interface screen shown in FIG. 6. Then, the control unit 94 stops the taking-in of images shot by the video-camera 102. Simultaneously, the control unit 94 obtains the contents selected from the field “observation CH” (that is, the selected contents of the optical wavelength range), closes one corresponding to the selected contents of the shutters 23a-23c (shutter 23c corresponding to the “CH1” in the example shown in FIG. 6) and shuts the optical path 4c.

In this case, since the display/output circuit 100 extinguishes a display device corresponding to the closed one of the shutters 23a-23c, the user can know that the optical path 4c is appropriately closed.

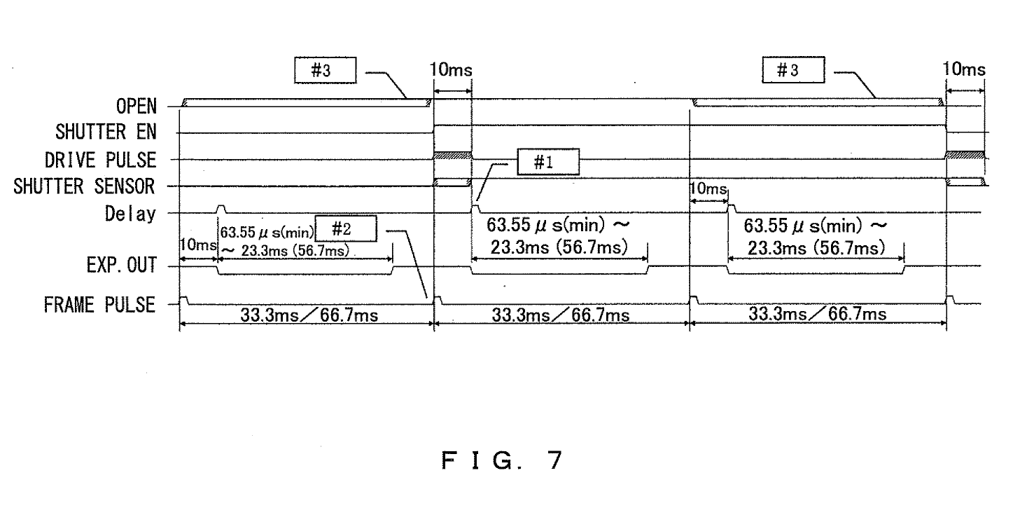

Next, FIG. 7 is described. FIG. 7 shows the timing of each control signal in a “TV camera reference mode (Exposure type)”.

The video-camera 102 transmits a signal “EXT.OUT” indicating exposure time to the wavelength range selector unit 92 via the signal cable 104. Firstly, the synchronous circuit 97 synchronizes the rising edge of a pulse signal “Delay” for operating the shutters 23a-23c with the falling edge of this signal “EXT.OUT” to generate the pulse signal “Delay” (#1 in FIG. 7). The synchronous circuit 97 also generates a pulse signal which is earlier than the pulse signal “Delay” by time set in an item “shutter phase” of the field “PLL” of the synchronous setting screen shown in FIG. 5 as a “frame pulse” (#2 in FIG. 7).

This “frame pulse” is used as a timing signal for the driver circuit 98 receiving various types of instructions from the control unit 94. Specifically, the driver circuit 98 determines the logic of a signal “OPEN” indicating the shoot/shoot stop instruction transmitted from the control unit 94 in total asynchronization with the image shooting of the video-camera 102 at the rising time of the “frame pulse”. Therefore, the driver circuit 98 can always open/close the shutters 23a-23c in timing synchronous with the frame rate of an image shot by the video-camera 102 (#3 in FIG. 7).

In FIG. 7, a signal “shutter EN” instructs the opening/closing operation of the shutters 23a-23c inside the driver circuit 98. A signal “drive pulse” is a short pulse given to a motor for driving to open/close the shutters 23a-23c, which is not shown in FIG. 7, and is generated by the driver circuit 98 every time the logic of the “shutter EN” is inverted. A signal “shutter sensor” indicates the open/closed states of the shutters 23a-23c, which is transmitted from the sensor units 99a-99c. When the completion of the opening/closing of the shutters 23a-23c is confirmed by the signal “shutter sensor”, the driver circuit 98 finishes the generation of the signal “drive pulse”.

The transmittance of the ND filters 21 and 22a-22c can be adjusted arbitrarily by the control input section 200 on the user interface screen shown in FIG. 6 during imaging.

In FIG. 6, in a field “ND adjustment”, the transmittance of light by the ND filter 21 can be set and is used to adjust the amount of light of the entire optical system shown in FIG. 2. In a field “ND individual adjustment”, “CH1”, “CH2” and “CH3” can set the transmittance of light by the ND filters 22c, 22b and 22a, respectively.

Next, the case where light in a plurality of wavelength ranges extracted by the wavelength range selector unit 92 is used as lighting light is described.

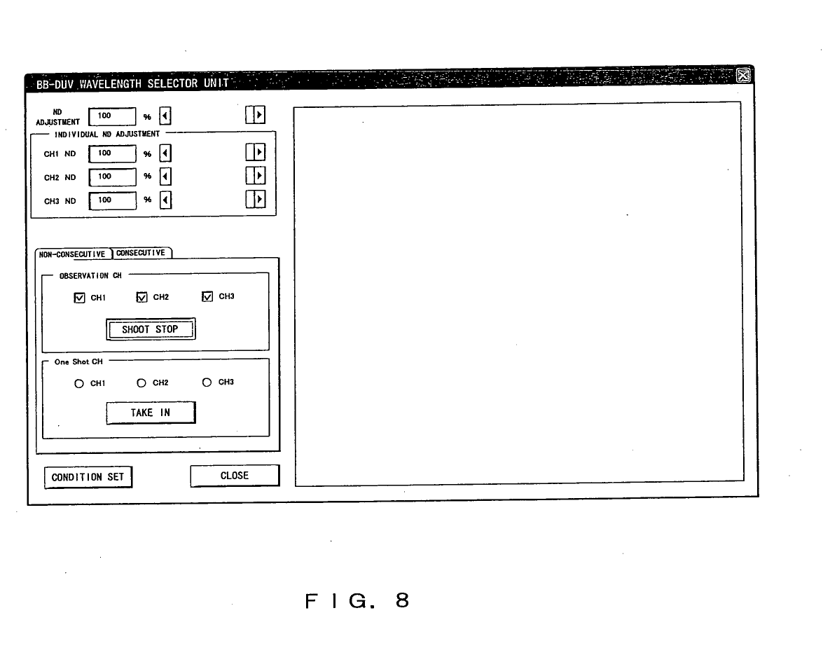

For this purpose, it is sufficient only if a user marks the checkbox of each observation channel corresponding to the wavelength of light to be desired to use in arbitrary timing in the field “observation CH” of the control input unit 200 on the user interface screen shown in FIG. 6. FIG. 8 shows that all of the “CH1”, “CH2” and “CH3” are selected in this case.

When an observation channel is selected, the control unit 94 instructs the wavelength range selector unit 92 to use the selected observation channel via the control cable 95.

In this case, the timing of each control signal of the wavelength range selector unit 92 is basically the same as one shown in FIG. 7.

The selection/non-selection of the “CH2” and “CH3” corresponds to the opening/closing of the shutters 23b and 23a, respectively. When the open instruction signal of the shutters 23a and 23b is outputted in the timing of a “frame pulse”, the shutters 23a and 23b are opened and the light of corresponding optical paths 4b and 4a are combined and used for lighting. Specifically, light in a plurality of wavelength ranges can be simultaneously applied to a specimen 83 to be observed or measured. If the field “observation CH” is unmarked in this state, of the shutters 23a-23c (optical paths 4a-4c), corresponding one closes and a corresponding wavelength range is excluded from lighting light for imaging.

In this case, the spectral strength of each wavelength range of the light source 1 varies depending on a used lamp and also the transmittance of the optical paths 4a-4c varies widely in a certain range. Therefore, there is a possibility that lighting strength may vary among wavelength ranges by the exchange of a light source lamp or an instrumental difference.

In order to avoid this, the microscope system shown in FIG. 1 is provided with the adjustment function of lighting strength among wavelengths.

The adjustment between wavelength ranges of lighting strength is performed as follows. Specifically, firstly, the lighting strength of light in the darkest wavelength range is assumed to be 100%. Then, the ND filters 22a-22c are adjusted in such a way that the lighting strength of light in the other wavelengths may coincide and the positions after this adjustment of the ND filters 22a-22c are registered as reference points.

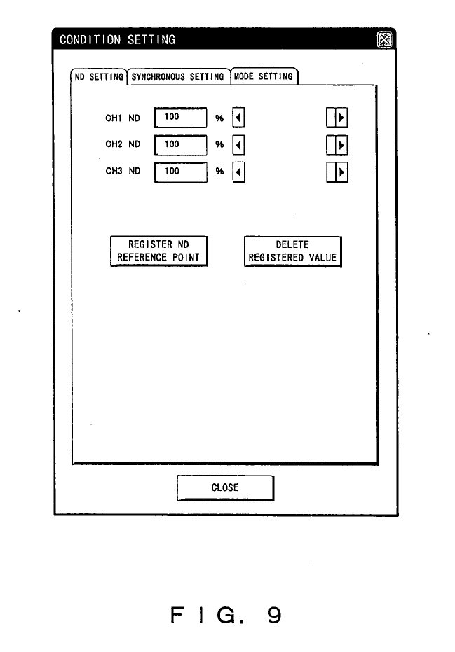

Next, FIG. 9 is described. FIG. 9 shows the example of an ND offset adjustment screen. This screen is displayed when the tab “ND setting” is selected on the condition setting screen displayed when the button “condition setting” is pushed down on the user interface screen shown in FIG. 3, 6 or 8.

When the lighting strength of wavelength ranges varies widely by lamp exchange or the like, the ND offset adjustment screen is displayed by selecting the tab “ND setting” on the condition setting screen and a button “Delete registered value” is pushed down. Then, the existing reference point data stored in the driver circuit 98 so far is cleared to restore the variation adjustment in all the wavelength ranges of the lighting strength to the initial state. Then, sliders provided for each observation channel is adjusted in such a way that the lighting strength of all the wavelength ranges may become equal, on the basis of the darkest wavelength range (one of the “CH1”, “CH2” and “CH3”).

If the lighting strength of each wavelength range is determined, a button “Register ND reference point” is pushed down. Then, the driver circuit 98 stores the relative amount of offset. Then, at the time of initialization, after the origins of the ND filters 22a-22c are detected in each wavelength range, the setting of the relative amount of offset is applied to each of the ND filters 22a-22c. Thus, the balance among the lighting strength of all the wavelength ranges is maintained.

In the above-described operation of the microscope system shown in FIG. 1, the synchronous signal outputted by the video-camera 102 can also be a vertically synchronous signal. In this case, the radio button “TV camera reference mode (VSYNC type)” is selected on the mode setting screen shown in FIG. 4.

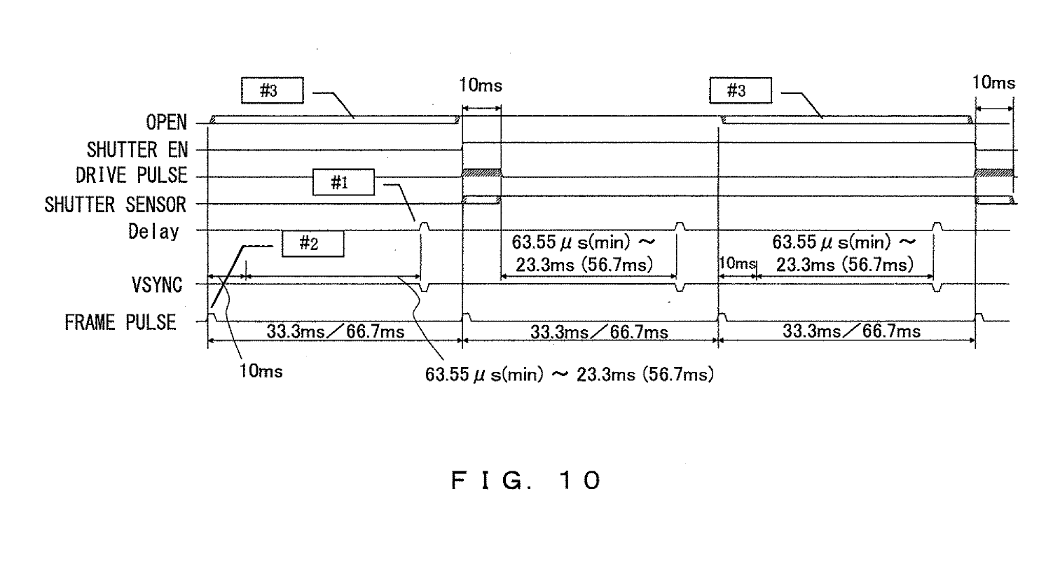

Next, FIG. 10 is described. FIG. 10 shows the timing of each control signal in the “TV camera reference mode (VSYNC type)”.

In this case, a signal “VSYNC” is transmitted to the wavelength range selector unit 92 from the video-camera 102. Then, the synchronous circuit 97 firstly synchronizes the rising edge of the pulse signal “Delay” for operating the shutters 23a-23c with the falling edge of this signal “VSYNC” to generate the pulse signal “Delay” (#1 in FIG. 10). The synchronous circuit 97 also generates a pulse signal which is earlier than this pulse signal “Delay” by the total time of time set in the item “shutter phase” of the field “PLL” on the synchronous setting screen shown in FIG. 5 and exposure time in one frame shot by the video-camera 102 as a “frame pulse” (#2 in FIG. 10).

This “frame pulse” is used as a timing signal for the driver circuit 98 receiving various types of instructions from the control unit 94 as in FIG. 7. Specifically, the driver circuit 98 determines the logic of a signal “OPEN” indicating the shoot/shoot stop instruction transmitted from the control unit 94 in total asynchronization with the image shooting of the video-camera 102 at the rising time of the “frame pulse”. Therefore, the driver circuit 98 can always open/close the shutters 23a-23c in timing synchronous with the frame rate of an image shot by the video-camera 102 (#3 in FIG. 10).

Each of signals “shutter EN”, “drive pulse” and “shutter sensor” is the same as one shown in FIG. 7.

As described above, in the microscope system shown in FIG. 1, a user can instruct the video-camera 102 to shoot and select lighting without being aware of the lighting timing of the light source 1 by selecting the “TV camera reference mode” as the operation method of the lighting wavelength range selector unit 91. The user can open/close the shutters 23a-23c in appropriate timing (units of frame of an image shot by the video-camera 102) by the lighting wavelength range selector unit 91 without applying lighting unnecessary in terms of both a wavelength range and time to a specimen 83 to be observed or measured. Furthermore, since the contrast of an obtained image can be adjusted by using a combination of light in different wavelength ranges for the lighting of the specimen 83 to be observed or measured, the amount of information which can be obtained in the same number of times of inspections increases.

Next, the operation in the case where the microscope system shown in FIG. 1 temporarily switches light in different wavelength ranges as lighting light and shoot an image in the state where the “TV camera reference mode” is selected as the operation method of the lighting wavelength range selector unit 91, light in one or more wavelength ranges is selected for lighting and normal observation is performed (hereinafter this operation is called “one-shot operation” is described).

It is now assumed that the “CH1” (optical path 4c) is selected as an observation channel and normal observation is performed. In this case, the user interface screen shown in FIG. 6 is displayed on the monitor device of the control unit 94.

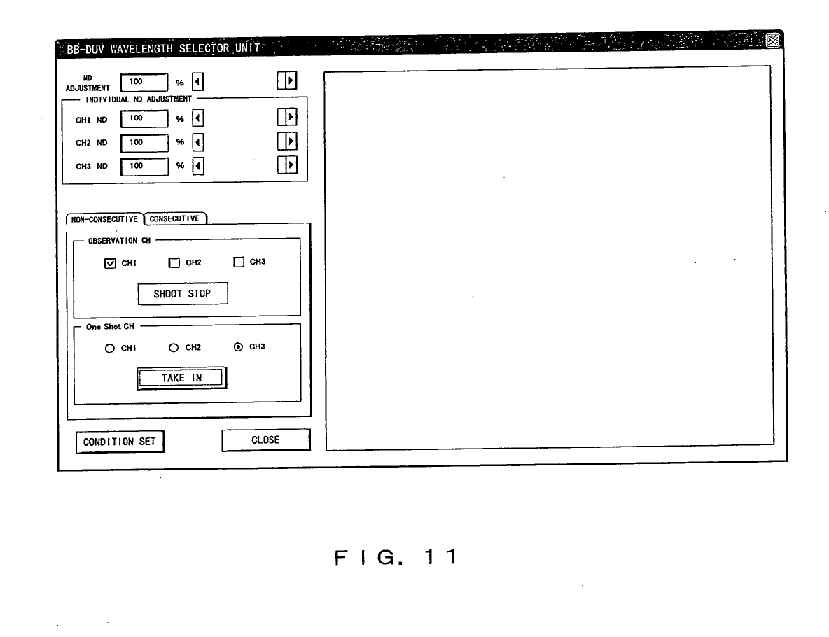

In this case, a user firstly marks one in the field “One Shot CH” of the control input unit 200 on the user interface screen to designate a temporarily switched observation channel. FIG. 11 shows the example of the user interface screen on which a temporarily switched observation channel is designated and in this example, the “CH3” is designated.

Then, the user pushes down a button “take in” in the field “One Shot CH” in arbitrary timing. Then, when detecting this operation, the control unit 94 instructs the wavelength range selector unit 92 to interrupt the shutter operation of a corresponding observation channel via the control cable 95.

Upon receiving this interrupt instruction, the wavelength range selector unit 92 closes a shutter (shutter 23c in the example shown in FIG. 11) corresponding to the observation channel used for lighting so far (“CH1” in the example shown in FIG. 11) and shifts a shutter (shutter 23a in the example shown in FIG. 11) corresponding to an observation channel the temporary switch to which is selected to a transmitting state in the timing of a subsequent image frame while continuing to take in an image shot by the video-camera 102. As a result, light passing through the optical path 4a is used for lighting.

Then, after time equivalent to one frame of an image shot by the video-camera 102 elapses, the shutter (shutter 23a in the example shown in FIG. 11) is automatically shifted to the original closed state and the shutter corresponding to the observation channel used for normal observation so far (shutter 23a in the example shown in FIG. 11) is automatically shifted to the original transmitting state. As a result, a normal observation state in which light passing through the optical path 4a is used for lighting is retuned.

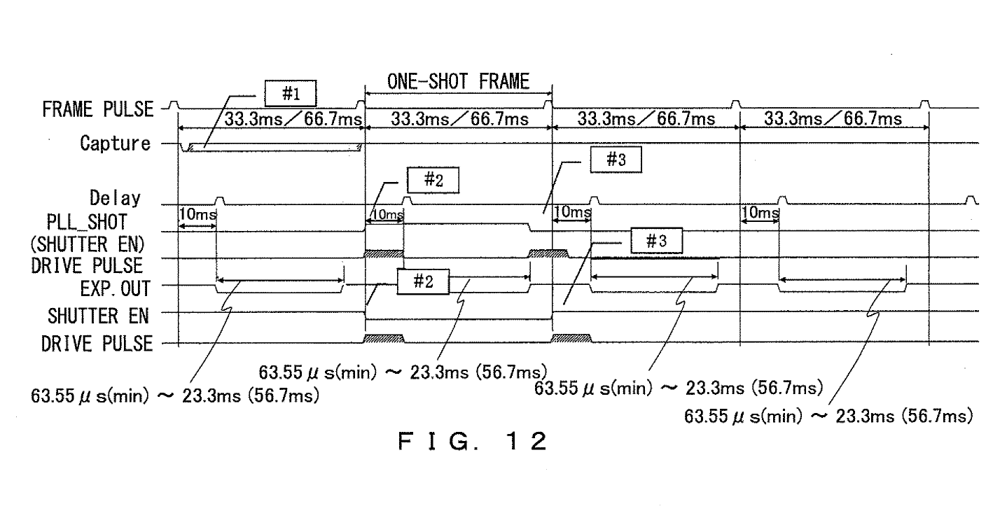

FIG. 12 shows the timing of each control signal in the above-described one-shot operation. This is the timing of the “TV camera reference mode (Exposure type)” and as in FIG. 7, it is assumed that the video-camera 102 transmits a signal “EXT.OUT” indicating exposure time to the wavelength range selector unit 92 via the signal cable 104.

In FIG. 12, a signal “shutter EN” instructs the opening/closing operation of a shutter corresponding to an observation channel used for normal observation (shutter 23c in the example shown in FIG. 11). A signal “PLL_SHOT” instructs the opening/closing operation of a shutter corresponding to an observation channel the temporary switch of which is designated in one-shot operation (shutter 23a in the example shown in FIG. 11).

The synchronous circuit 97 synchronizes the rising edge of a pulse signal “Delay” for operating the shutters 23a-23c with the falling edge of this signal “EXT.OUT” to generate the pulse signal “Delay”. Furthermore, the synchronous circuit 97 also generates a pulse signal which is earlier than the pulse signal “Delay” by time set in an item “shutter phase” of the field “PLL” of the synchronous setting screen shown in FIG. 5 as a “frame pulse”.

In this case, when the user pushes down the button “take in”, the control unit 94 issues a signal “Capture” to the wavelength range selector unit 92 by the logic of low-active (#1 in FIG. 12). The driver circuit 98 determines the latched signal “Capture” at the rising time of the “frame pulse”. In this case, if it is determined that the signal is detected, the driver circuit 98 closes the shutter of a wavelength range selected in the field “observation CH” of the control input unit 200 on the user interface screen (shutter 23c in the example shown in FIG. 11). Simultaneously, the driver circuit 98 opens the shutter of a wavelength range selected in the field “One Shot CH” (shutter 23a in the example shown in FIG. 11) (#2 in FIG. 12).

Then, after a prescribed exposure time elapses, the shooting of one frame of an image in the video-camera 102 is completed and accordingly a subsequent “frame pulse” is generated, the driver circuit 98 opens the shutter of a wavelength range selected in the field “observation CH” (shutter 23c in the example shown in FIG. 11) in timing synchronous with the frame rate of an image shot by the video-camera 102 this time. Simultaneously, the driver circuit 98 closes the shutter of a wavelength range selected in the field “One Shot CH” (shutter 23a in the example shown in FIG. 11) to restore to the original normal observation.

Although in the above description of one-shot operation, the operation is in the “TV camera reference mode (Exposure type)”, this also applies to the operation in the “TV camera reference mode (VSYNC type)”, specifically the operation in the case where the synchronous signal transmitted to the wavelength range selector unit 92 from the video-camera 102.

As described above, thanks to the one-shot operation in the microscope system shown in FIG. 1, a user can switch lighting in synchronization with the frame of an image shot by the video-camera 102 simply by instructing the taking-in of the image without being aware of the application timing of light in a wavelength which the user desires to interrupt and apply. The shutters 23a-23c can be opened/closed in appropriate timing (units of frame of an image shot by the video-camera 102) by the lighting wavelength range selector unit 91 without applying lighting unnecessary in terms of a wavelength range and time to a specimen 83 to be observed or measured. Furthermore, since the acquisition can be completed by lighting for just the minimum necessary time even if light in a wavelength range having energy sufficient to damage the specimen 83 is selected as lighting light when obtaining image data for observation/measurement, the damage of the specimen 83 can be reduced.

Next, the operation in the case where in the microscope system shown in FIG. 1, light in at least two or more wavelength ranges is selected as lighting light and the shooting of a specimen 83 is sequentially performed switching the wavelength range of the lighting light (hereinafter this operation is called “sequential image taking-in operation”) is described.

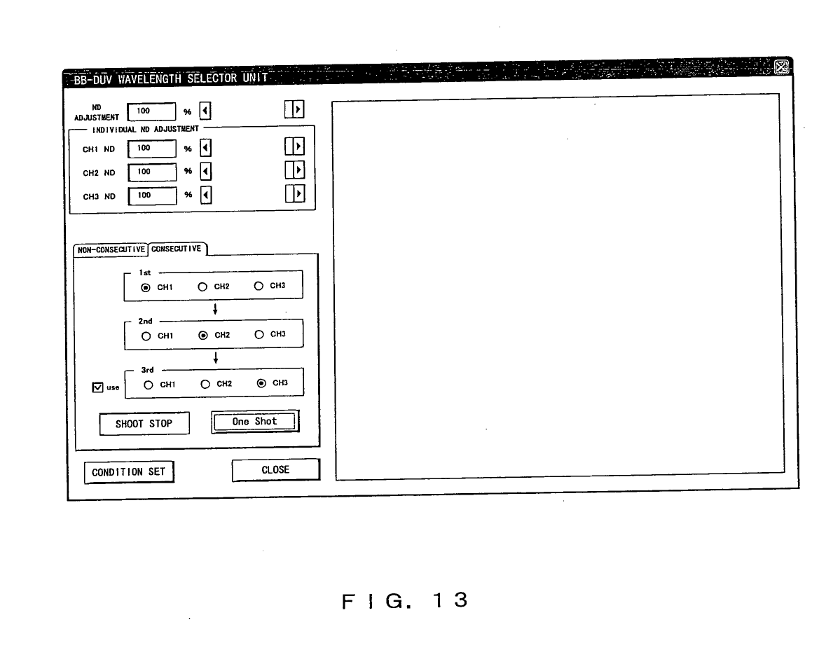

When a tab “consecutive” provided for the control input unit 200 on the user interface screen shown in FIG. 3 is selected, the control unit 94 switches the user interface screen to that shown in FIG. 13. A user selects an observation channel corresponding to light in a desired wavelength range as lighting light according to a desired switching order by the radio button on this screen. In the example shown in FIG. 13, the state in which lighting light is switched in the order of “CH1”, “CH2” and “CH3” is selected.

Then, the user pushes down a button “shooting start”, which is not shown in FIG. 13, in arbitrary timing. Then, the control unit 94 changes the button “shooting start” to a button “shoot stop”. FIG. 13 shows the state in which this button modification has been performed.

When detecting the pushing-down operation of the button “shooting start”, the control unit 94 instructs the operation order of the shutters 23a-23c corresponding to a selected observation channel to the wavelength range selector unit 92 via the control cable 95. Then, the control unit 94 starts the taking-in process of an image shot by the video-camera 102. Simultaneously, the control unit 94 instructs the driver circuit 98 to obtain contents selected in the field “1st” on the user interface screen shown in FIG. 13, open one corresponding to the selected contents of the shutters 23a-23c (shutter 23c corresponding to “CH1” in the example shown in FIG. 13) and specify only light in the selected wavelength range (optical path 4c) as lighting light.

In this case, after the shooting of one frame of an image by the video-camera 102 is completed, the control unit 94 instructs the driver circuit 98 to close one corresponding to the contents selected in the “1st” on the user interface screen of the shutters 23a-23c (shutter 23c corresponding to “CH1” in the example shown in FIG. 13) this time. Simultaneously, the control unit 94 opens one corresponding to contents selected in a field “2nd” (shutter 23b corresponding to “CH2” in the example shown in FIG. 13) and specifies only light in the selected wavelength range (optical path 4b) as lighting light.

Then, similarly, after the shooting of one frame of an image by the video-camera 102 is completed, the control unit 94 instructs the driver circuit 98 to close one corresponding to the contents selected in the field “2nd” on the user interface screen (shutter 23b corresponding to “CH2” in the example shown in FIG. 13). Simultaneously, the control unit 94 opens one corresponding to contents selected in a field “3rd” (shutter 23a corresponding to “CH3” in the example shown in FIG. 13) and specifies only light in the selected wavelength range (optical path 4a) as lighting light.

After this, similarly, the control unit 94 instructs the driver circuit 98 to open one corresponding to contents selected in the field “1st” on the user interface screen, one corresponding to contents selected in the field “2nd” and one corresponding to contents selected in the field “3rd” of the shutters 23a-23c. Simultaneously, the control unit 94 closes the others and specifies light in a wavelength range which is obtained then as lighting light. Thus, the driver circuit 98 switches light to be shut by the shutters 23a-23c.

The image taking-in in this sequential image taking-in operation can be terminated by pushing down the button “shoot stop” provided on the user interface screen shown in FIG. 13. Then, the control unit 94 stops the taking-in process of an image shot by the video-camera 102. Simultaneously, the control unit 94 instructs the driver circuit 98 to close all the shutters 23a-23c to close all the optical paths 4a-4c.

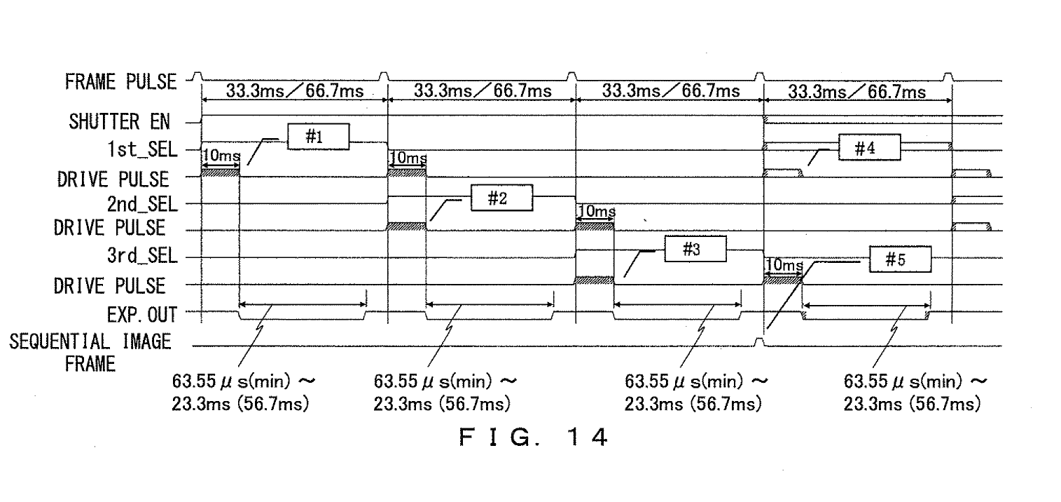

FIG. 14 shows the timing of each control signal in the above-described sequent image taking-in operation. This is the timing of the “TV camera reference mode (Exposure type)” and as in FIG. 7, it is assumed that the video-camera 102 transmits a signal “EXP.OUT” indicating exposure time to the wavelength range selector unit 92 via the signal cable 104. As in FIG. 7, the synchronous circuit 97 generates a pulse signal which is earlier than the falling edge of the signal “EXP.OUT” by time set in the item “shutter phase” of the field “PLL” on the synchronous setting screen shown in FIG. 5 as a “frame pulse”.

In FIG. 14, a signal “shutter EN” instructs the common opening/closing operation of the shutters 23a-23c inside the driver circuit 98. Each of “1st_SEL”, “2nd_SEL” and “3rd_SEL” is the instruction signal of the opening/closing operation corresponding to contents selected in the fields “1st”, “2nd” and “3rd” on the user interface screen shown in FIG. 13 of the shutters 23a-23c. Furthermore, a signal “sequential image frame” is a pulse signal generated every time the switch of the wavelength range of light does one round.

Firstly, the driver circuit 98 determines the logic of a signal indicating a shoot/shoot stop instruction transmitted from the control unit 94 at the rising time of the “frame pulse”. In this case, if a shoot instruction is detected, firstly, the driver circuit 98 opens one corresponding to contents selected in the field “1st” on the user interface screen shown in FIG. 13 of the shutters 23a-23c (shutter 23c corresponding to “CH1” in the example shown in FIG. 13) (#1 in FIG. 14).

Then, when a subsequent “frame pulse” is generated accordingly after the shooting of one frame of an image by the video-camera is completed, one corresponding to contents selected in the field “1st” on the user interface screen (shutter 23c corresponding to “CH1” in the example shown in FIG. 13) closes and one corresponding to contents selected in the field “2nd” (shutter 23b corresponding to “CH2” in the example shown in FIG. 13) opens (#2 in FIG. 14).

Then, when a subsequent “frame pulse” is generated accordingly after the shooting of one frame of an image by the video-camera is completed, one corresponding to contents selected in the field “2nd” on the user interface screen (shutter 23b corresponding to “CH2” in the example shown in FIG. 13) closes and one corresponding to contents selected in the field “3rd” (shutter 23a corresponding to “CH3” in the example shown in FIG. 13) opens (#3 in FIG. 14).

If a subsequent “frame pulse” is generated following the completion of the shooting of one frame of an image by the video-camera 102 when shooting continues after that, one corresponding to contents selected in the field “1st” on the user interface screen (shutter 23c corresponding to “CH1” in the example shown in FIG. 13) opens and the others are closed (#4 in FIG. 14). Thus, the switch of light for closing the shutters 23a-23c is always performed in timing synchronous with the frame rate of an image shot by the video-camera 102.

In this case, the driver circuit 98 detects the logic of a shoot stop instruction issued from the control unit 94 in the timing of the pulse signal “sequential image frame” to stop the taking-in of an image (#5 in FIG. 14). Therefore, even if the shoot stop instruction is issued in arbitrary timing, the image taking-in can be always stopped after the switch of the wavelength ranges of lighting light does one round and images shot under lighting light in all the wavelength ranges are prepared.

If a button “One Shot” shown in FIG. 13 is pushed down instead of the button “shoot start” on the user interface screen shown in FIG. 13, the one-shot operation of sequential image taking-in, specifically, only one round of the operation of sequentially taking in images is started. However, if the button “One Shot” is pushed while the button “shooting start” is in advance pushed to start the sequential image taking-in operation, this push-down is neglected.

Although in the above description of the sequential image taking-in operation, the operation is performed in the “TV camera reference mode (Exposure type)”, this also applies to the operation in the “TV camera reference mode (VSYNC type)”, specifically the operation in the case where the synchronous signal transmitted to the wavelength range selector unit 92 from the video-camera 102 is vertical one.

Although in the above description of the sequential image taking-in operation, light in three wavelength ranges is designated as lighting light, light in two wavelength ranges can also be designated and alternately used as lighting light by unmarking “use” provided on the user interface screen shown in FIG. 13 instead. Light in more than three wavelength ranges can also be made to use by modifying the optical system of the wavelength range selector unit 92 and accordingly the microscope system shown in FIG. 1 can be configured to increase the setting of the switching order of the wavelength ranges of lighting light. The switching order of the wavelength ranges of lighting light can also arbitrarily set and therefore, the wavelength range can also be repeatedly selected. Alternatively, light in the same wavelength range can be consecutively used as lighting light.

As described above, thanks to the sequential image taking-in operation of the microscope system shown in FIG. 1, a user can switch lighting in synchronization with the frame of an image shot by the video-camera 102 by designating the order of lighting light in a plurality of wavelength ranges. The shutters 23a-23c can also be opened/closed in appropriate timing (units of frame of an image shot by the video-camera 102) by the lighting wavelength range selector unit 91 without applying lighting unnecessary in terms of both a wavelength and time to a specimen 83 to be observed or measured. Furthermore, even if light in a plurality of wavelength ranges is selected as lighting light, the acquisition of image data can be completed in frame time according to the designated number of wavelength ranges.

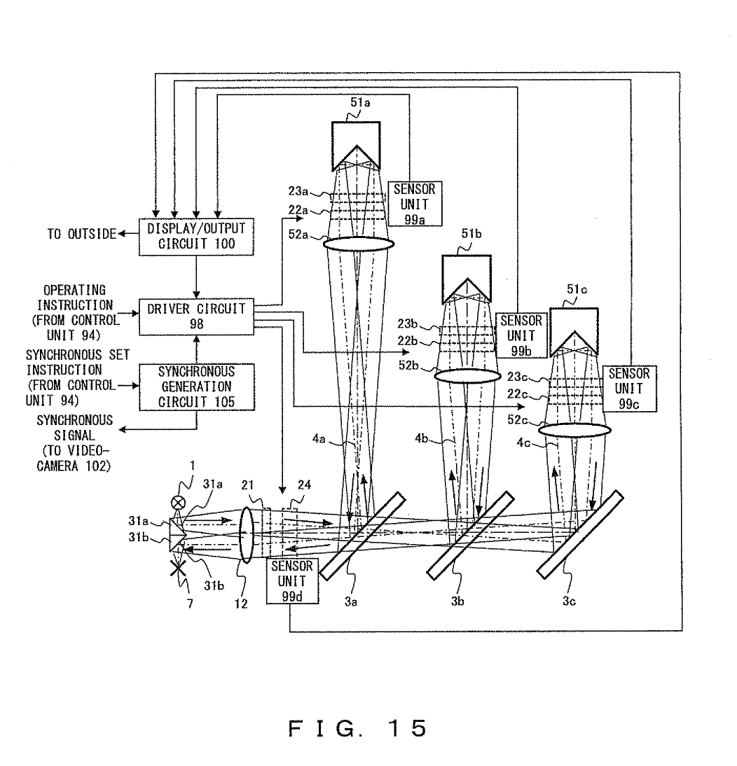

Next, FIG. 15 is described. FIG. 15 shows the second example of the internal configuration of the wavelength range selector unit 92 of the microscope system shown in FIG. 1. This is configured to generate a synchronous signal by the wavelength range selector unit 92, give the synchronous signal to the video-camera 102 and shoot an image according to this synchronous signal.

In the optical system shown in FIG. 15, components to which the same numerical references as in FIG. 2 are attached are the same components as in FIG. 2 and their detailed descriptions are omitted.

The configuration shown in FIG. 15 differs from the first one shown in FIG. 2 in only that a synchronous generation circuit 105 is provided instead of the synchronous circuit 97.

The synchronous generation circuit 105 generates a trigger signals corresponding to various types of time settings, such as shutter phase, a frame rate, exposure time and the like which the control unit 94 gives via the control cable 95 inside it. Simultaneously, the synchronous generation circuit 105 generates prescribed signals synchronous with these trigger signals and outputs the synchronous signals to the external video-camera 102.

When the wavelength range selector unit 92 configured as shown in FIG. 15 is used in the microscope system shown in FIG. 1, the video-camera 102 is set in a mode of shooting an image in synchronization with an externally-given synchronous signal. More specifically, in this operation mode, an image and image data is transferred according to an externally-inputted trigger signal and the exposure time of the video-camera 102 is determined by the pulse width of the trigger signal.

Next, the operation in the case where in the microscope system configured as described above, light in at least one or more wavelength ranges is selected for lighting and a specimen 83 is consecutively shot is described.

The user of the microscope system instructs the control unit 94 to execute a control program recorded in advance in the control unit 94. Then, as described above, the control unit 94 controls the driver circuit 98 to initialize each of the ND filters 21 and 22a-22c, the shutters 23a-23c and the light source shutter 24 and also displays the user interface screen as shown in FIG. 3 as an example on the monitor device of the control unit 94.

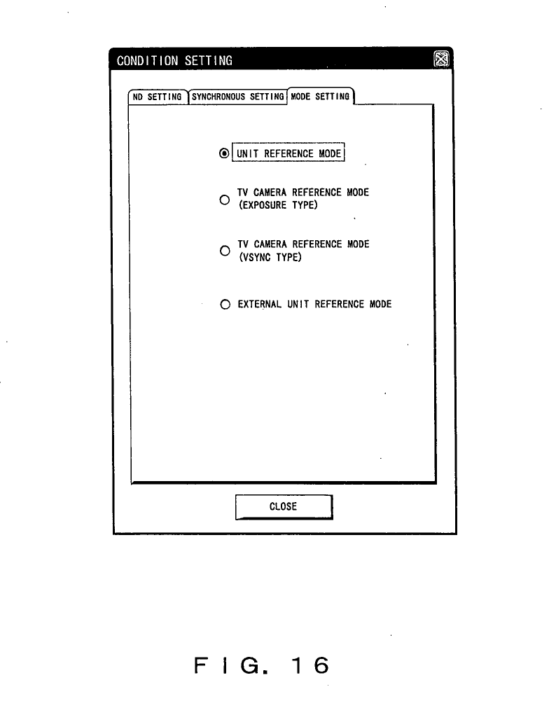

When in the screen shown in FIG. 3, a button “condition set” disposed in the lower left section is pushed down, the condition setting screen is displayed on the monitor device. Then, when a tab “mode setting” included in the condition setting screen is selected, the mode setting screen as shown in FIG. 16 as an example is displayed on the condition setting screen.

In this case, as shown in FIG. 16, a user selects a “unit reference mode” of the operation modes displayed on the mode setting screen. This operation mode gives a trigger signal generated by the synchronous generation circuit 105 to an external video-camera 102 to operate the video-camera 102 synchronizing the operation timing with that of the lighting wavelength range selector unit 91.

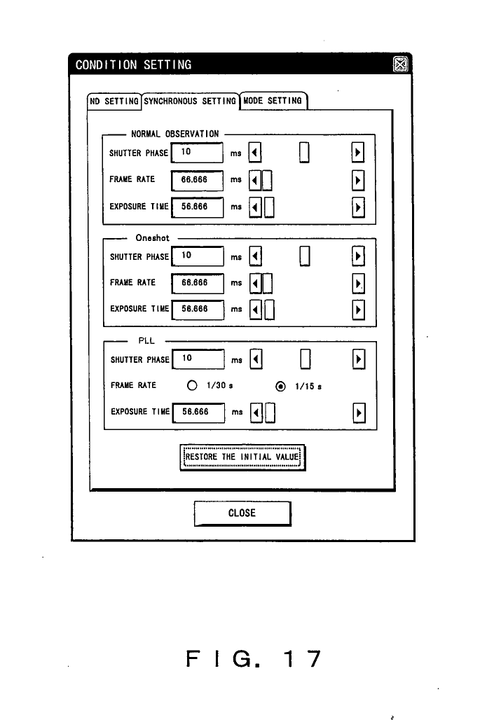

If a tab “synchronous setting” included in the condition setting screen is selected after this selection, the synchronous setting screen shown in FIG. 17 as an example is displayed on the condition setting screen. The screen example shown in FIG. 17 shows that, of three fields of “normal observation”, “One shot” and “PLL”, the fields “normal observation” and “One shot” are valid and the timing of a trigger signal given to the video-camera 102 is set by the settings of these fields.

Next, each item of the field “normal observation” on the synchronous setting screen is described. In the item “shutter phase”, time for delaying the opening/closing of the shutters 23a-23c (settling time) is set. In the item “frame rate”, the frame rate of a dynamic image shot by video-camera 102 is set. Furthermore, in item “exposure time”, an actual exposure time (shutter speed) of the video-camera 102 is set.

When these settings are performed, thanks to the function of the synchronous generation circuit 105, the image taking-in operation of the video-camera 102 can be synchronized with the selection operation of the wavelength range of lighting light of the wavelength range selector unit 92 in prescribed timing.

When a button “close” disposed in the lower section of the condition setting screen is pushed down after this, the condition setting screen closes and the original user interface screen shown in FIG. 3 is displayed. In this case, as described above, the button “shooting start” is pushed down after selecting the checkbox “CH1” in the field “observation CH” of the control input section 200. Then, the control unit 94 changes this user interface screen as shown in FIG. 6 and changes the button “shoot start” to the button “shoot stop”.

When detecting the push-down of the button “shoot start”, the control unit 94 instructs the wavelength range selector unit 92 to use light in a wavelength range corresponding to the selected observation channel as lighting light via the control cable 95. Then, the taking-in process of an image shot by the video-camera 102 starts. Simultaneously, of the shutters 23a-23c, one corresponding to a setting in the field “observation CH” on the user interface screen (shutter 23c corresponding to the “CH1” in the example shown in FIG. 6) opens and only light in the selected wavelength range (optical path 4c) is specified as lighting light.

In this case, the synchronous generation circuit 105 transmits a trigger signal (synchronous signal) to the video-camera 102. Therefore, the video-camera 102 starts/finishes exposure according to the pulse width of this trigger signal and transfers the data of a shot image to the control unit 94.

Since as described above, the display/output circuit 100 lights a display device corresponding to open one of the shutters 23a-23c, a user can know that the optical path 4c appropriately opens.

The image taking-in can be terminated after this by pushing down the button “shoot stop” disposed in the field “observation CH” of the control input unit 200 on the user interface screen shown in FIG. 6. Then, the control unit 94 stops the taking-in process of an image shot by the video-camera 102. Simultaneously, the control unit 94 closes one corresponding to contents selected in the field “observation CH” of the shutters 23a-23c (shutter 23c corresponding to “CH1” in the example shown in FIG. 6) to close the optical path 4c.

Since as described above, the display/output circuit 100 lights a display device corresponding to open one of the shutters 23a-23c, a user can know that the optical path 4c appropriately opens.

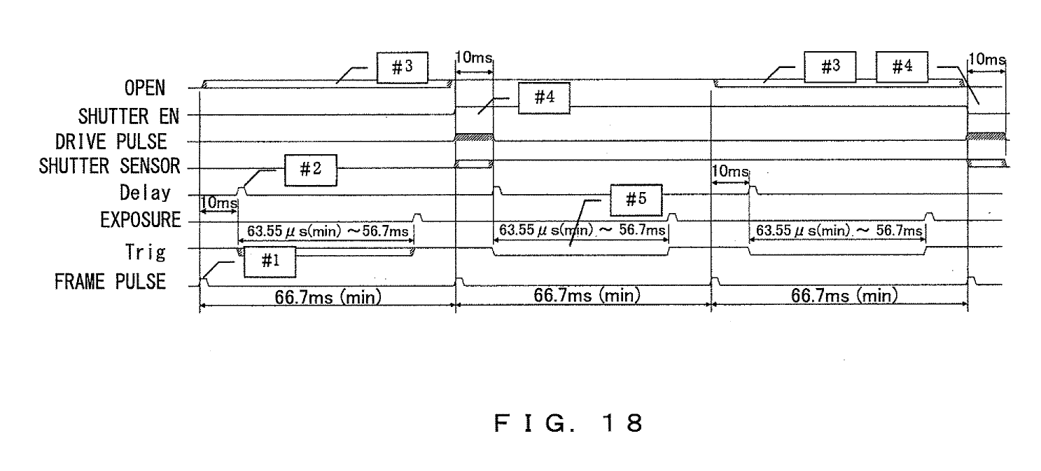

Next, FIG. 18 is described. FIG. 18 shows the timing of each control signal in the “unit reference mode”.

Firstly, the synchronous generation circuit 105 obtains time set in the item “frame pulse” of the field “normal observation” on the synchronous setting screen shown in FIG. 17 and consecutively generates a “frame pulse” the cycle of which is the time (#1 in FIG. 18). The “frame pulse” is used as a timing signal for the driver circuit 98 receiving various types of instructions from the control unit 94.

The synchronous generation circuit 105 also generates a pulse signal which is later than this “frame pulse” by time set in the item “shutter phase” of the field “normal observation” on the synchronous setting screen shown in FIG. 17 as “Delay” (#2 in FIG. 18). This “Delay” is used to determine the timing of releasing the shutters 23a-23c.

As described above, the “frame pulse” is used as a timing signal for the driver circuit 98 receiving various types of instructions from the control unit 94. Therefore, the driver circuit 98 determines the logic of a signal “OPEN” indicating shoot/shoot stop instruction transmitted from the control unit 94 in total asynchronization with the image shooting of the video-camera 102 at the rising time of the “frame pulse” (#3 in FIG. 18). Therefore, the driver circuit 98 can always open/close the shutters 23a-23c in timing synchronous with the frame rate of an image shot by the video-camera 102 (#4 in FIG. 18).

The synchronous generation circuit 105 generates a signal “Trig”, which is a frame rate signal for reporting a frame rate when shooting the observation image of a specimen 83 and also determining the exposure time of the video-camera 102 in synchronization with the “frame pulse” and transmits the signal “Trig to the video-camera 102 (#5 in FIG. 18). This signal “Trig” maintains a low level for time designated/set in the item “exposure time” of the “normal observation” on the synchronous generation circuit shown in FIG. 17 and this time corresponds to the exposure time of the video-camera 102. Therefore, by modifying the setting value of the “exposure time”, the same function as the adjustment of the ND filter 21 can be obtained.

These time settings can be modified on the synchronous setting screen shown in FIG. 17 even during the image taking-in operation. When this setting value is modified, all the timing modifications of each control signal on the basis of the modification are reflected in the timing of a “frame pulse”.

Next, the case where in the “unit reference mode”, light in a plurality of wavelength ranges which is extracted by the wavelength range selector unit 92 is used as lighting light is described.

For that purpose, as described above, it is sufficient if a user marks the checkbox of each observation channel corresponding to a light wavelength range desired to use in the field “observation CH” of the control unit on the user interface screen shown in FIG. 6 in arbitrary, as shown in FIG. 8.

When an observation channel is selected, the control unit 94 instructs the wavelength range selector unit 92 to use the selected observation channel via the control cable 95.

The timing of each control signal of the wavelength range selector unit 92 in this case is basically the same as shown in FIG. 18.

The selection/non-selection of “CH2” and “CH3” corresponds to the opening/closing of the shutters 23b and 23a, respectively. When the open instruction signals of the shutters 23a and 23b are outputted at the timing of a “frame pulse”, the shutters 23a and 23b open, respectively, and the light of corresponding optical paths 4a and 4b, respectively, are used for lighting. Specifically, the image shooting operation of the video-camera 102 can be synchronized using a pulse signal generated by the synchronous generation circuit 105 and also light in a plurality of wavelength ranges can be applied to a specimen 83 to be observed or measured simultaneously. If the “observation CH” is unmarked in this state, of the shutters 23a-23c (optical paths 4a-4c), corresponding one closes and a corresponding wavelength range is excluded from lighting light for shooting.

In the above-described “unit reference mode”, one-shot operation can also be performed as in the above-described “TV camera reference mode”.

This preferred embodiment is configured in such a way that each value of items “shutter phase”, “frame rate” and “exposure time” of the one-shot operation in the “unit reference mode” can be set independently of the normal observation operation by setting the field “One shot” on the synchronous setting screen shown in FIG. 17.

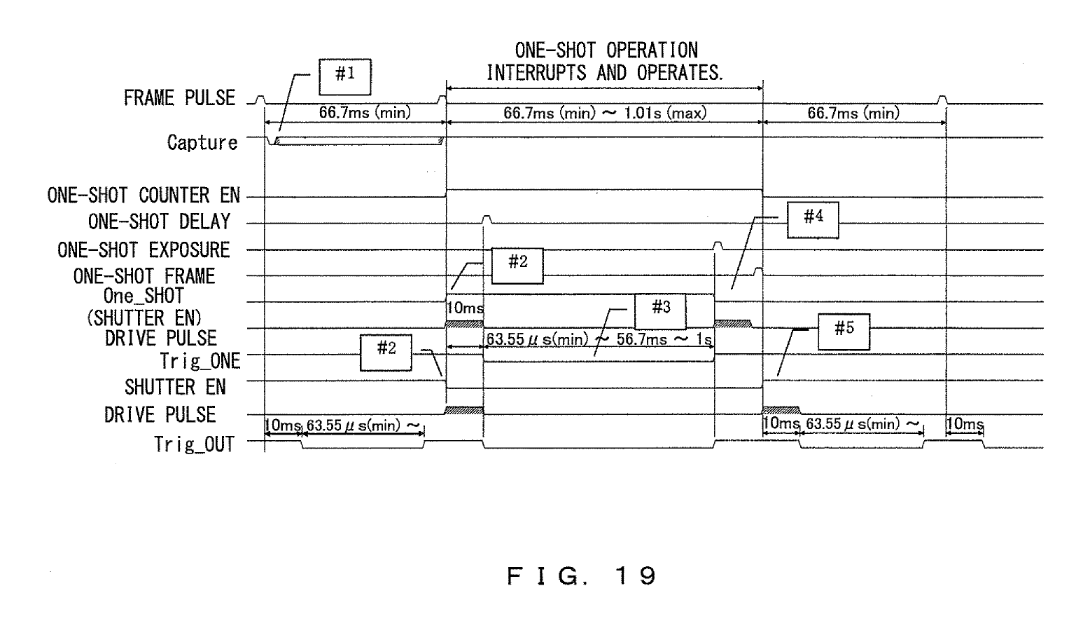

Next, FIG. 19 is described. FIG. 19 shows the timing of each control signal of the one-shot operation in the “unit reference mode”.

For example, if a user pushes down the button “take in” of the field “One Shot CH” at arbitrary timing in the state where normal observation is performed in the “unit reference mode” by selecting and operating the control input unit 200 on the user interface screen as shown in FIG. 11, the control unit 94 issues a signal “Capture” to the wavelength range selector unit 92 by the logic of low active (#1 in FIG. 19).

The driver circuit 98 determines the latched signal “Capture” at the rising time of the “frame pulse”. In this case, if it is determined that the signal is detected, the shutter of a wavelength range selected in the field “observation CH” of the control input section 200 on the user interface screen (shutter 23c in the example shown in FIG. 11) closes and the shutter of a wavelength range selected in the field “One Shot CH” (shutter 23a in the example shown in FIG. 11) opens (#2 in FIG. 19). Immediately after this, the timing switches to the synchronous one for one-shot operation and a trigger signal “Trig_ONE” which becomes low level for time set in the item “exposure time” of the field “One Shot” on the synchronous setting screen is transmitted to the video-camera 102 (#3 in FIG. 19).

Then, after the shooting of one frame of an image by the video-camera 102 is completed, this time the shutter of a wavelength range selected in the field “One Shot CH” (shutter 23a in the example shown in FIG. 11) closes (#4 in FIG. 19). Then, the shutter of a wavelength range selected in the field “observation CH” (shutter 23c in the example shown in FIG. 11) opens (#5 in FIG. 19) and the original normal observation returns.

Besides, in the above-described “unit reference mode”, a sequential image taking-in operation and a sequential one-shot taking-in operation can also be performed as in the “TV camera reference mode”.

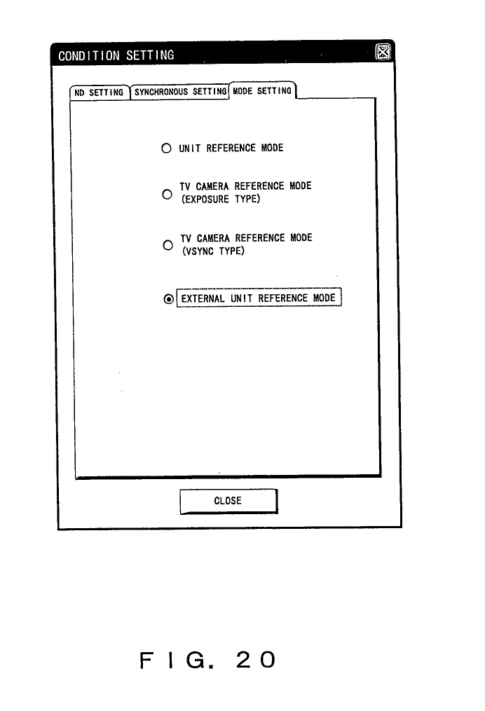

On the mode setting screen of the above-described condition setting screen, as shown in FIG. 20, an “external unit reference mode” can also be selected. The “external unit reference mode” stops the function of the synchronous generation circuit 105 shown in FIG. 15 and opens/closes the shutters 23a-23c according to an instruction from the control unit 94. By selecting this mode, the wavelength range selector unit 92 operates only by an instruction from the control unit 94. Therefore, by enabling the control unit 94 to execute a program to control the operation procedure of each unit of the wavelength range selector unit 92, the adjustment of the ND filters 22a-22c and the opening/closing of the shutters 23a-23c can be freely combined and controlled in arbitrary timing.

As described above, by providing the configuration of the wavelength range selector unit 92 which is shown in FIG. 15 and selecting the “unit reference mode”, a user can instruct the shooting of the video-camera 102 and the selection of lighting without being aware of the lighting timing of the light source 1. The shutters 23a-23c can be opened/closed in appropriate timing (units of frame of an image shot by the video-camera 102) by the lighting range selector unit 91 without applying lighting unnecessary in terms of both a wavelength range and time to a specimen 83 to be observed or measured. Furthermore, since by using light obtained by combining light in different wavelength ranges for the lighting of the specimen 83 to be observed or measured, the contrast of an obtained image can be adjusted, the amount of information which can be obtained in the same number of times increases.

A user can switch lighting synchronous with the frame of an image shot by the video-camera 102 simply by instructing the taking-in of the image without being aware of the lighting timing of light in a wavelength range desired to interrupt and apply. The shutters 23a-23c can be opened/closed in appropriate timing (units of frame of an image shot by the video-camera 102) by the lighting range selector unit 91 without applying lighting unnecessary in terms of both a wavelength range and time to a specimen 83 to be observed or measured. Furthermore, since even if light in a wavelength range having energy sufficient to damage a specimen 83 is selected when obtaining image data for observation/measurement, the acquisition can be completed for the minimum necessary time, the damage of the specimen 83 can be reduced.

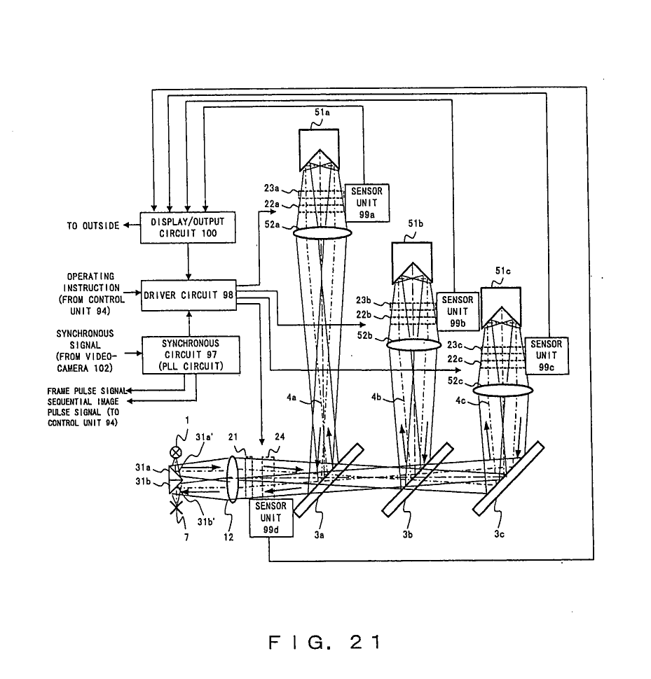

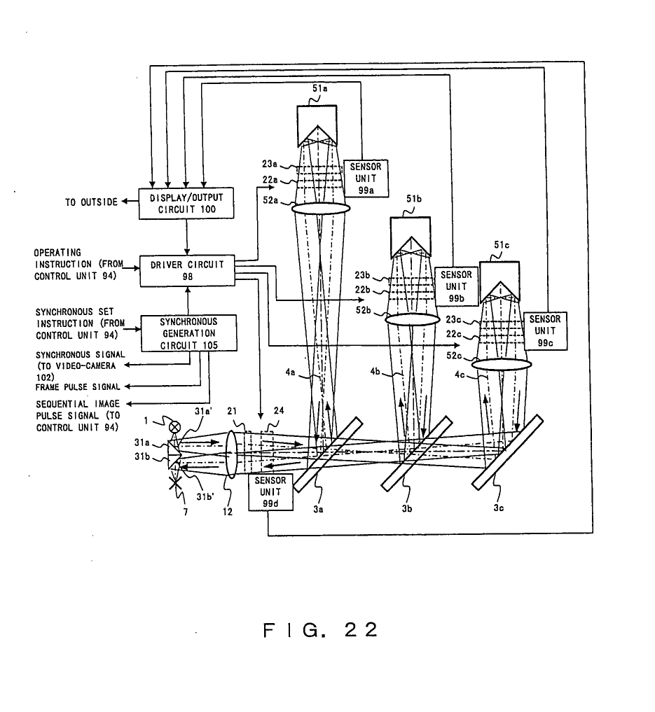

As shown in FIGS. 21 and 22, an interface for outputting a frame pulse signal and a sequential image pulse signal from the synchronous circuit 97 (in the case of FIG. 21) or the synchronous generation circuit 105 (in the case of FIG. 22) can also be provided in the configurations shown in FIGS. 2 and 15, which can be connected to the control unit 94 via the control cable 95. By such a configuration, even if the load of the MPU of a computer provided for the control unit 94 becomes too much and the process time of the image taking-in process exceeds the frame rate of a dynamic image, the image taking-in process can be re-synchronized with the image shooting of the video-camera 102. Furthermore, in the sequential image taking-in operation, the image taking-in process can be surely synchronized with the order of images transmitted from the video-camera 102.

Although each preferred embodiment of the present invention has been described so far, the present invention is not limited to the above-described preferred embodiments and various improvements/modifications are also possible as long as the subject matter of the present invention is not deviated.

For example, for the wavelength range of light extracted from the light of a light source, for example, a visible range or an infrared range can be used instead of an ultraviolet range. Alternatively, one obtained by combining these wavelength ranges can be used. The number of the wavelength ranges of light extracted from a light source can be arbitrary and is not limited to the three of the preferred embodiments.

For example, the configuration of an optical system for extracting light with a specific wavelength from the light of a light source is not also limited to those of the above-described preferred embodiments and another configuration can also be used. Each of the mirror and lens used in the preferred embodiments can also be replaced with a publicly known optical device, such as a prism or the like. Alternatively, one obtained by combining them can be used. The optical system can also be modified from a reflection type to a transmitting type, for example, by using a dichroic filter for transmitting only light in a desired wavelength range instead of the dichroic mirror.

What is claimed is:

1. A lighting device, comprising:
a plurality of wavelength range extraction unit for extracting light in different wavelength ranges from light of a light source;
a shutter unit for shutting each piece of light extracted by each of the wavelength range extraction units;
a selector unit for selecting light to be shut by the shutter unit; and
a combiner unit for combining a plurality of pieces of light that is not shut by the shutter unit.

2. The lighting device according to claim 1, wherein
the selector unit selects light to be shut by the shutter unit in timing synchronous with a frame rate of imaging an observation image by a video-camera for imaging the observation image of a specimen to which light combined by the combiner unit is applied.

3. The lighting device according to claim 2, further comprising
a switch unit for switching selection by the selector unit in timing synchronous with a frame rate of imaging the observation image by the video-camera.

4. The lighting device according to claim 3, wherein
the switch unit restores the selection in timing synchronous the frame rate a prescribed time later after switching of selection by the selector unit.

5. The lighting device according to claim 1, further comprising
a shutter control unit for controlling the shutter unit to stop application of light to the specimen after exposure time for imaging the observation image by a video-camera for imaging an observation image of a specimen to which light combined by the combiner unit is applied elapses.

6. The lighting device according to claim 1, further comprising
a shutter status display unit for displaying the shutter status of the shutter unit.

7. The lighting device according to claim 1, further comprising
a frame rate signal generator unit for generating a frame rate signal for reporting a frame rate when imaging an observation image of a specimen to which light combined by the combiner unit is applied and transmitting it to a video-camera for imaging the observation image.

8. The lighting device according to claim 7, wherein
the frame rate signal includes information for determining exposure time for imaging the observation image by the video-camera.

9. The lighting device according to claim 1, further comprising:
a screen display unit for displaying various types of information screens; and
an instruction acquisition unit for obtaining various types of instructions,
wherein
the screen display unit displays an information screen indicating information for specifying a wavelength range of each piece of light extracted by the wavelength range extraction unit,
the instruction acquisition unit obtains a select instruction of a wavelength range of the light and
the selector unit selects light to be shut by the shutter unit according to a select instruction obtained by the instruction acquisition unit.

10. The lighting device according to claim 3, further comprising:
a screen display unit for displaying various types of information screens; and
an instruction acquisition unit for obtaining various types of instructions,
wherein
the screen display unit displays an information screen indicating information for specifying a wavelength range of each piece of light extracted by the wavelength range extraction unit,
the instruction acquisition unit obtains an instruction of a selection switching order of the selector unit and
the switch unit switches selection of the sector unit in an order according to an instruction of a selection switching order obtained by the instruction acquisition unit.

11. The lighting device according to claim 7, further comprising:
a screen display unit for displaying various types of information screens; and
an instruction acquisition unit for obtaining various types of instructions,
wherein
the screen display unit displays an information screen indicating a frame rate value reported by the frame rate signal,
the instruction acquisition unit obtains an instruction of the frame rate value and
the frame rate signal generator unit generates a frame rate signal for reporting a frame rate value of an instruction obtained by the instruction acquisition unit.

12. The lighting device according to claim 8, further comprising:
a screen display unit for displaying various types of information screens; and
an instruction acquisition unit for obtaining various types of instructions,
wherein
the screen display unit displays an information screen indicating exposure time determined by information included in the frame rate signal,
the instruction acquisition unit obtains an instruction of the exposure time and
the frame rate generator unit generates a frame rate signal including information for determining exposure time of an instruction obtained by the instruction acquisition unit.

13. The lighting device according to claim 1, further comprising
a condensing optical system for condensing light emitted by the light source and emitting parallel luminous flux.

14. The lighting device according to claim 13, wherein
each of the plurality of wavelength range extraction unit comprises
an optical device for selectively extracting light in a prescribed wavelength range from light emitted by the light source; and
an optical system for folding flux of light extracted by the optical device in symmetry against an optic axis of the optical system,
wherein
the condensing optical system forms an image of the light source by condensing luminous light folded by the folding optical system via the optical device.

15. The lighting device according to claim 14, wherein
the optical device is a dichroic mirror for reflecting light in the prescribed wavelength range and transmitting light in others than the prescribed wavelength range.

16. The lighting device according to claim 14, wherein
the optical device is a dichroic mirror for transmitting light in the prescribed wavelength range and reflecting light in others than the prescribed wavelength range.

17. The lighting device according to claim 14, wherein
the folding optical system is disposed on an optic axis of the optical device and folds flux of light extracted by the optical device.

18. The lighting device according to claim 14, wherein
the folding optical system included in each of the plurality of wavelength range extraction units is disposed in each of positions where the optical path length from the condensing optical system is equal.

19. A microscope system provided with a lighting device, wherein
the lighting device comprises
a plurality of wavelength range extraction unit for extracting light in different wavelength ranges from light of a light source;
a shutter unit for shutting each piece of light extracted by each of the wavelength range extraction units;
a selector unit for selecting light to be shut by the shutter unit; and
a combiner unit for combining a plurality of pieces of light that is not shut by the shutter unit.
